(19) United States
(12) Patent Application Publication
(10) Pub. No.: US 2008/0162437 A1
(43) Pub. Date: Jul. 3, 2008

(54) METHOD AND SYSTEM FOR IMAGE-BASED SEARCHING

(75) Inventors: Ji Hoon Choi, Yongin-si (KR); Jungmin Lee, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: NHN CORPORATION, Seongnam-Si (KR)

(21) Appl. No.: 11/965,581

(22) Filed: Dec. 27, 2007

(30) Foreign Application Priority Data
Dec. 29, 2006 (KR) 10-2006-0138100

(51) Int. Cl. G06F 17/30

(52) U.S. Cl. 707/3; 707/E17.108

(57) ABSTRACT

Disclosed is a method of operating an image-based searching engine. In the method, data for a plurality of images displayed on a web page is sent to a user's terminal. The engine receives, from the user's terminal, a user's input comprising a selection of at least one of the plurality of images. Subsequently, at least one search term associated with the selection is provided and a search using the at least one search term is conducted. After the search, a result of the search is sent to the user's terminal.

### CROSS-REFERENCE TO RELATED APPLICATION

This application is based on and claims priority from Korean Patent Application No. 10-2006-0138100 filed on Dec. 29, 2006 in the Korean Intellectual Property Office, the disclosure of which is incorporated herein in its entirety by reference.

### BACKGROUND

1. Field

The present disclosure relates to method and system for providing a search service, and more particularly, to image-based searching.

2. Discussion of the Related Technology

A general search-service-providing system includes a database that stores website information classified according to predetermined standards, a search robot that mechanically collects website information while touring the web, a search engine that searches a database, generates a search result corresponding to the request for a search, and provides the generated search result to a user when there is a request for a search from the user.

Further, the search-service-providing system stores website information collected by the search robot and website information by the request of an advertiser in the database.

When the user inputs a text corresponding to a search word in a search window, the search-service-providing system extracts information corresponding to the search word from the website information stored in the database, and provides the extracted information to the user as the search result.

Hence, in the case of the existing search-service-providing system, if the user clearly recognizes which word should be searched, a desired search result can be provided, but if the user does not clearly recognize which word should be searched, for example, if the user remembers the image of a mobile phone, but does not know the model name, the user cannot input the accurate search word in the search window, so a desired search result cannot be provided.

Also, if there are several aliases for the inputted word, the existing search-service-providing system may not be able to provide a desired search result, which is a problem.

Hence, because most of users are more familiar with images than text-type search words, there is a great need for a service that allows a search using an image.

The foregoing discussion is to provide general background information, and does not constitute an admission of prior art.

### SUMMARY

One aspect of the invention provides a method of operating an image-based searching engine, which comprises: sending, to a user's terminal, data for a plurality of images displayed on a web page; receiving, from the user's terminal, a user's input comprising a selection of at least one of the plurality of images; providing at least one search term associated with the selection; conducting a search using the at least one search term; and sending a result of the search to the user's terminal.

In the foregoing method, the at least one search term may be provided using a database, which comprises a plurality of entries, wherein each entry may comprise an image and an term associated with the image.

Still in the foregoing method, the user's input may comprise two or more images of materials for use in cooking, wherein the search result may comprise at least one of a name of food or a recipe that are prepared using the materials. The user's input may comprise at least one image of cookware or a kitchen appliance, wherein the search result may comprise a link for a web page including a recipe for food that uses the cookware or kitchen appliance.

Yet in the foregoing method, the plurality of images may comprise a map of a region, which comprises a plurality of selectable sub-regions, wherein when the user's input may comprise an image of the sub-regions. The user's input may comprise an image representing a broadcast service provider and a date, wherein the search result may comprise a broadcast schedule of the broadcast service provider on the date. The user's input may comprise an image of a product available at an Internet store, wherein the search result may comprise at least one of the name of Internet store and a link to open the Internet store's web page.

Further in the foregoing method, the data may be configured to arrange the plurality of images on the web page based on at least one selected from the group consisting of: advertisement information of whether images were registered for advertisement; and popularity of images during a prior operation of the image-based searching engine.

Another aspect of the invention provides a method of using an image-based searching service, which comprises: selecting at least one image from a plurality of images displayed on a web page for image-based searching service; subsequently sending a request for an Internet search, wherein the request identifies the at least one selected image; and receiving a result of the Internet search comprising a plurality of links to open Internet web pages.

In the foregoing method, selecting may comprise dragging and dropping the at least one image into a designated area of the web page. The search may be conducted using at least one term associated with the at least one selected image, wherein the at least one term may be provided using a database, which comprises a plurality of entries, wherein each entry may comprise an image and an term associated with the image.

Yet another aspect of the invention provides a method of using an image-based searching service, which comprises: receiving a transmission request to a web page from a user client; extracting at least one of image to be included in the web page from a database; generating a first GUI-search area including the extracted image; transmitting the web page that includes the first GUI-search area to the user client; and when a search request to at least one of the image included in the first GUI-search area is received from the user client, transmitting a search result corresponding to the search-requested image to the user client.

An aspect of the present invention is to provide a method and system for providing a GUI (Graphic User Interface) search service using an image.

Another aspect of the present invention is to provide a method and system for providing a GUI search service that can provide search results regarding all aliases related with an image at one time.

One embodiment of the present invention provides a method of providing a search service in a search server connected to a user client via a network, the method comprising keeping a database where images are stored; receiving a transmission request to a web page from a user client; extracting one or more images to be included in the web page from the database; generating a first GUI-search area including the extracted one or more images; transmitting the web page that includes the first GUI-search area to the user client; and when a search request to at least one of the images included in the first GUI-search area is received from the user client, transmitting a search result corresponding to the search-requested images to the user client.

Another embodiment of the present invention provides a method of providing a search service in a search server connected to a user client via a network, the method keeping a database where service images are stored; receiving a transmission request to a web page from the user client; generating a GUI-search area including one or more service images where the service includes information about a search range; transmitting the web page including the GUI-search area to the user client; and when the selection information about the service images and the search-word information inputted by the user are received, transmitting a search result corresponding to the search-words within the search range corresponding to the selected service images to the user client.

Yet another embodiment of the present invention provides a compute-readable recording medium that records a program that executes the above-stated method.

Yet another embodiment of the present invention, there is provided a system for providing a GUI-search service, the system comprising a database configured to store images; and a search server configured to transmit a web page including one or more images extracted from the database to a user client, and transmit a search result corresponding to the search-requested images to the user client when a search request to at least one of the images included in the web page is received from the user client.

### BRIEF DESCRIPTION OF THE DRAWINGS

The above and other features and advantages of the present invention will become apparent by describing in detail embodiments thereof with reference to the attached drawings in which:

FIG. 1 illustrates a configuration of a search-service-providing system according to an exemplary embodiment of the present invention.

FIG. 2 illustrates a detailed configuration of a search-service-providing system according to an exemplary embodiment of the present invention.

FIG. 3 illustrates a detailed configuration of a web page-generation unit according to an exemplary embodiment of the present invention.

FIGS. 4 to 7 are a flowchart illustrating a process of providing a GUI-search service according to embodiments of the present invention.

FIG. 8 is a flowchart illustrating a process of generating a GUI-search area according to an exemplary embodiment of the present invention.

FIGS. 9 and 10 illustrate an example of a product-GUI-search area according to an embodiment of the present invention.

FIG. 11 illustrates an example of a person-GUI-search area in a movie information page according to an embodiment of the present invention.

FIG. 12 illustrates an example of a person-GUI-search area in a music information page according to an embodiment of the present invention.

FIG. 13 illustrates an example of a person-GUI-search area in a news article page according to an embodiment of the present invention.

FIG. 14 illustrates an example of a person-GUI-search area in a search result page according to an embodiment of the present invention.

FIG. 15 illustrates an example of a broadcast-GUI-search area according to an embodiment of the present invention.

FIG. 16 illustrates an example of a map-GUI-search area according to an embodiment of the present invention.

FIG. 17 illustrates an example of a cooking-GUI-search area according to an embodiment of the present invention.

FIGS. 18 and 19 illustrate an example of a service-GUI-search area.

### DETAILED DESCRIPTION OF EMBODIMENTS

Exemplary embodiments of the present invention will be described in detail with reference to the accompanying drawings.

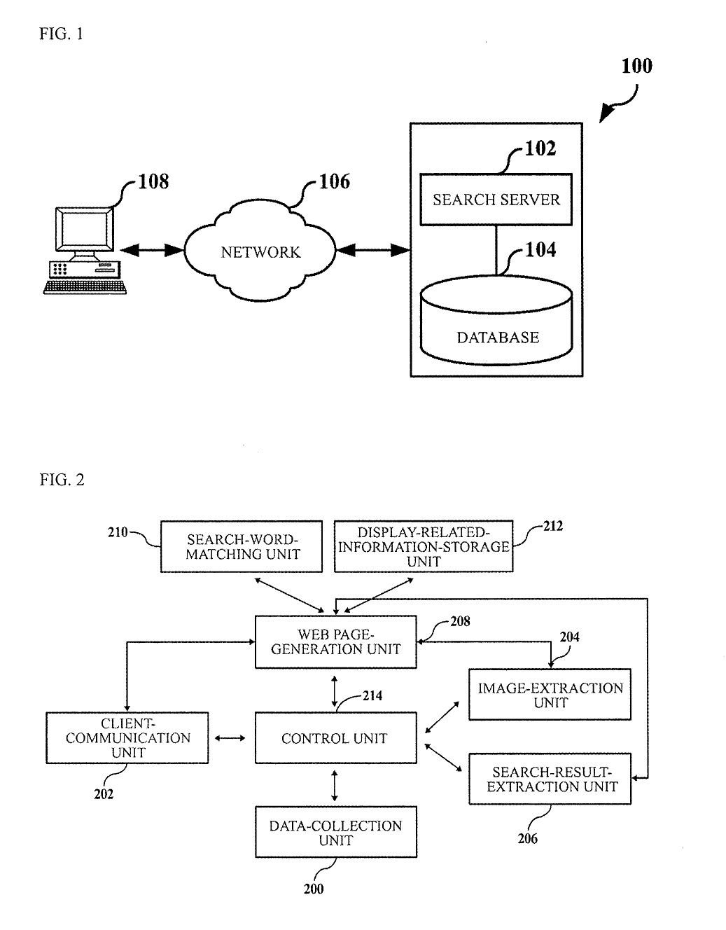

FIG. 1 illustrates a configuration of a search-service-providing system according to an exemplary embodiment of the present invention. As illustrated, the search-service-providing system 100 is connected a user client 108 through a network 106, and may include a search server 102 and a database 104.

Referring to FIG. 1, only a search server 102 is illustrated as a server that provides a search service to the user client 108, but it should be understood by those skilled in the art that a search service can be provided in a plurality of other servers that include a web server.

The network 106 can include a wire network and a wireless network including a wireless Internet, a mobile communication network, and a satellite communication network.

The user client 108 is a plurality of terminal devices that are connected to the network 106, send a search request to the search server 102, and receive the search result, and some examples of the user client 108 are a desktop personal computer, a notebook computer, a mobile phone, a PDA, and a mobile broadcast system (MBS).

The search server 102 collects all website information on the web, and stores the collected information in the database 104. When a search request is received from the user client 108, the search server 102 extracts the search result corresponding to the search word inputted by the user, and provides the extracted search result to the user client 108.

The search server 102 collects information on the web, for example, by reading other pages of other sites through hypertext links on each web page or the main page of all web sites using a search robot called Spider, Crawler or Bot. However, it should be understood by those skilled in the art that the method of collecting information on the web is not limited to the above-described method, but the information on the web can also be collected by searching directories classified by subjects.

The following description will assume that the information collected by the search server 102 is website information for explanatory convenience, but it will be clear to those skilled in the art that the website information in the present specification can include all information on the web.

The database 104 stores website information collected by the search server 14. Here, the database 104 can store the website information after indexing the information. Further, the database 104 according to an embodiment of the present invention stores all images that can be included in the web page.

According to an exemplary embodiment of the present invention, the search server 102 can provide a search service that can provide not only a search result corresponding to a text-type search word inputted by the user but also a search result corresponding to an image selected by the user.

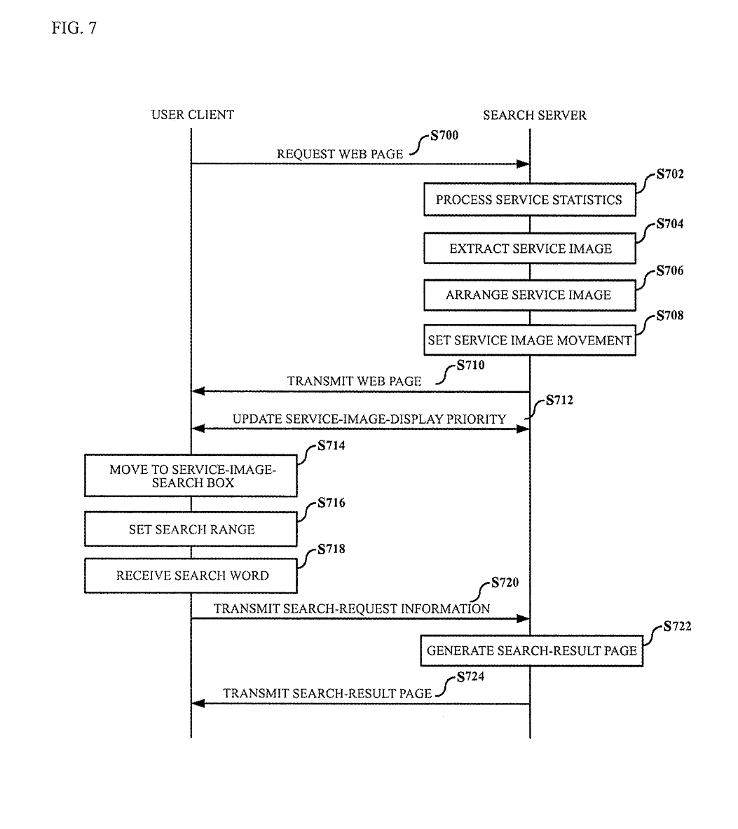

The search server 102 according to an exemplary embodiment of the present invention stores a search word related with images about products or persons, and when there is a request from the user, as illustrated in FIGS. 9 to 19, the search server 102 transmits web pages that allow a search request using images (web pages including a GUI-search area or image-based search area) to the user client 108.

Here, search words matched with an image can include a search word and other aliases. For example, as illustrated in FIG. 9, for a camera whose official model name is Contax IIId, aliases such as Contax 3d can be search words.

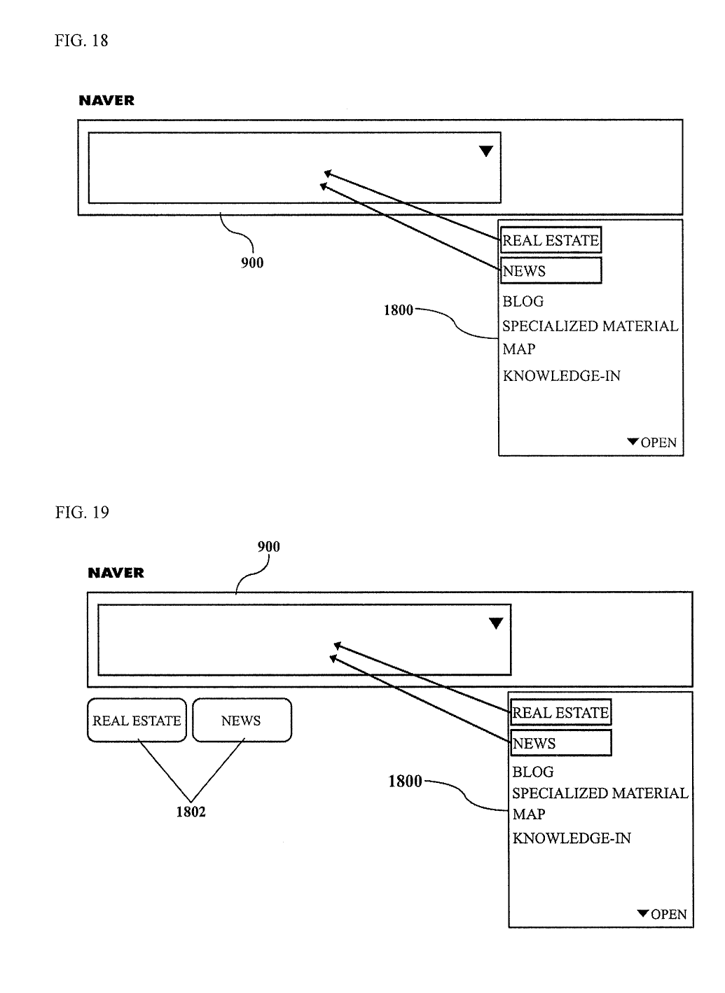

Further, according to an exemplary embodiment of the present invention, the GUI-search area can be included in main all pages that can be provided by the search server 102, such as a main page provided by the search server 102, a detailed information page about a certain category (e.g., shopping, a person, a broadcast, a map, cooking and a certain service), a search result page, and a page that includes a service image that defines a search range as illustrated in FIGS. 18 and 19.

The GUI-search area included in the above-described web page includes images and a search box 900, and the search server 102 can generate a web page so that one or more images included in the GUI-search area can move to the search box 900 within the web page when there is a selection from the user. Here, the search box 900 plays the role of containing images, but general texts can also be inputted in the search box 900.

According to an exemplary embodiment of the present invention, in order to implement image movement within a web page, the GUI-search area can be implemented through JavaScript or Ajax (Asynchronous JavaScript+XML), but the present invention is not limited to them. Anything that moves images to the search box 900 within the web page can be used.

If the user sends a search request by selecting one or more images among images included in the GUI-search image, the user client 108 transmits a search request about a search word matched with the selected image to the search server 102.

Here, the selection of an image can be executed through a method of moving to the search box, which can implemented by a drag and drop.

When a search request is received from the user client 108, the search server 102 extracts a search result corresponding to a search word matched with the image, and transmits the extracted the search result to the user client 108.

Embodiments of the present invention allows the user to intuitively select a to-be-searched object by implementing a method to send a search request using images, and to receive a search result corresponding to aliases for the image.

An example of a web page including a GUI-search area is described in the following with reference to FIGS. 9 to 19.

First, FIGS. 9 and 10 illustrate a web page including a GUI-search area about a camera and a mobile phone, respectively, and a user who wants to search a camera can send a search request by selecting one or more camera images illustrated in FIG. 9 to move the search box 900. As such, the user can obtain a desired search result even if the user does not know the model name for a certain camera.

Further, a user who wants to search a mobile phone can send a search request by selecting one or more mobile phone images illustrated in FIG. 10 to move the search box 900. In an exemplary embodiment of the present invention, mobile phone images can be displayed by makers in the GUI-search area, and mobile phone images with high search frequency or recommendation frequency or mobile phone images on which advertisement was requested can be preferentially displayed.

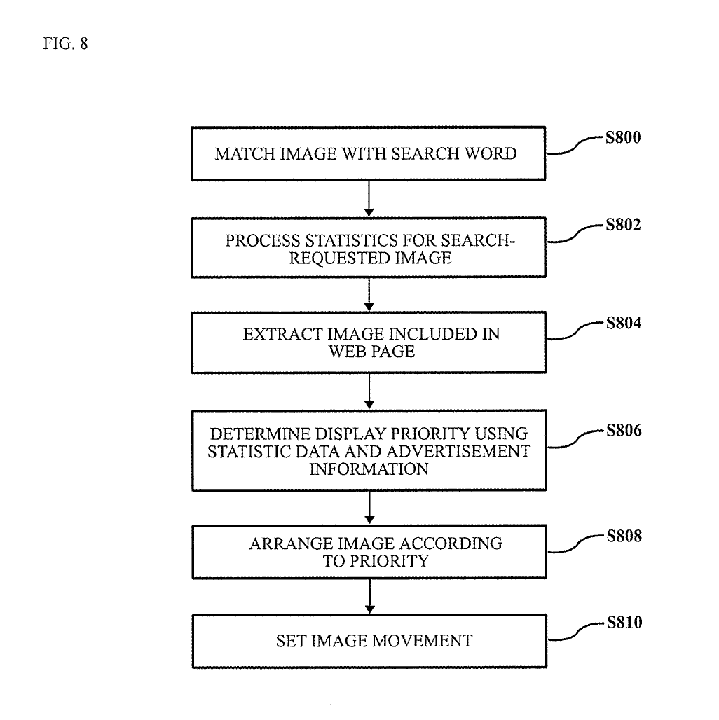

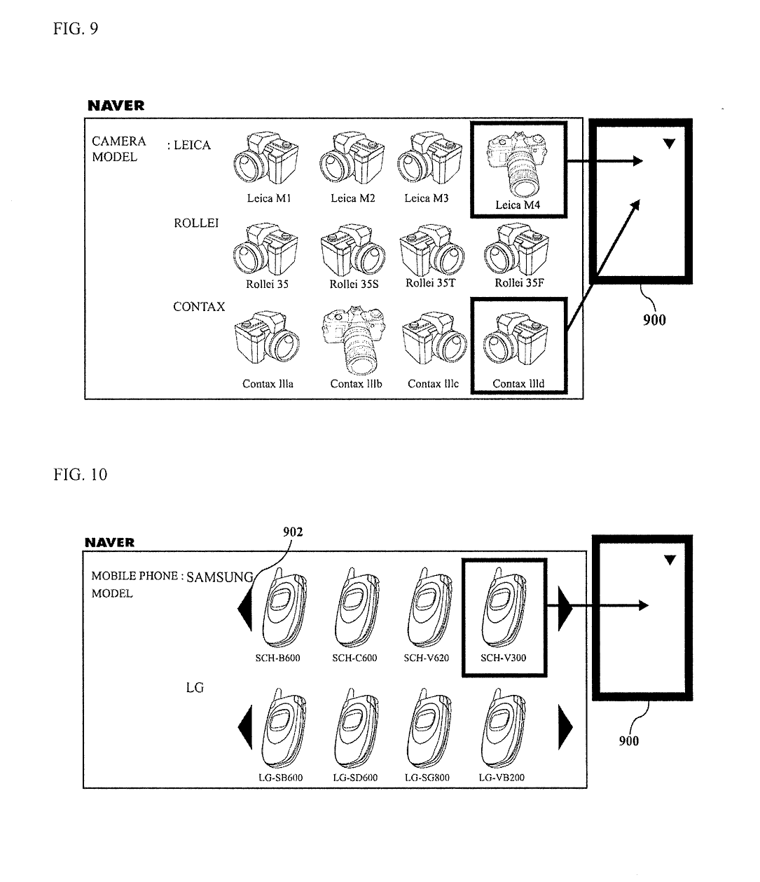

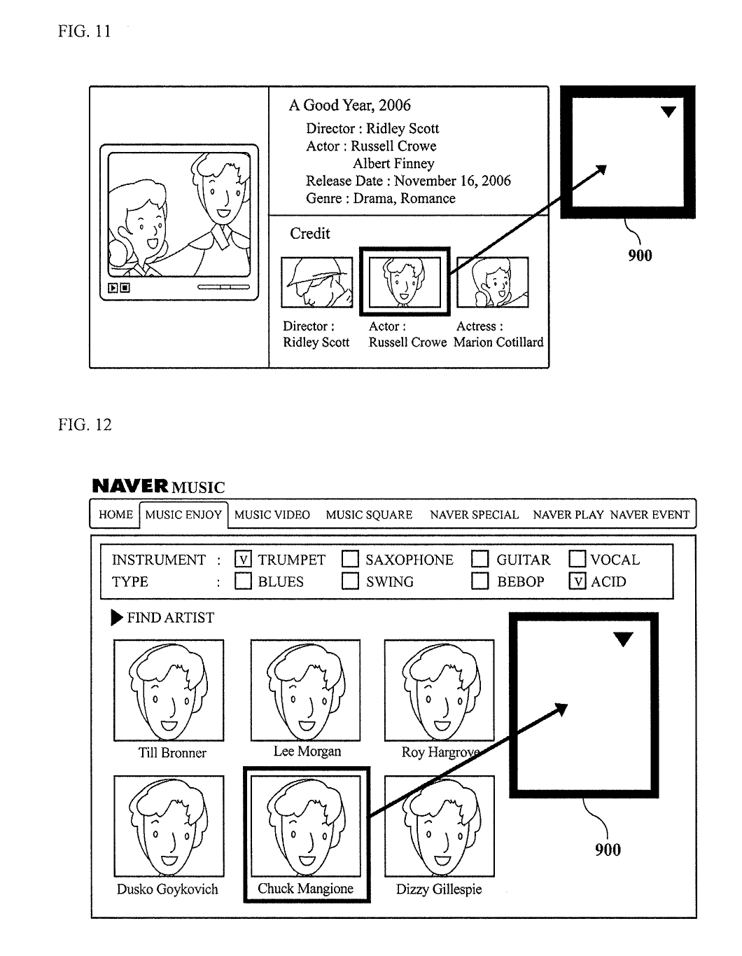

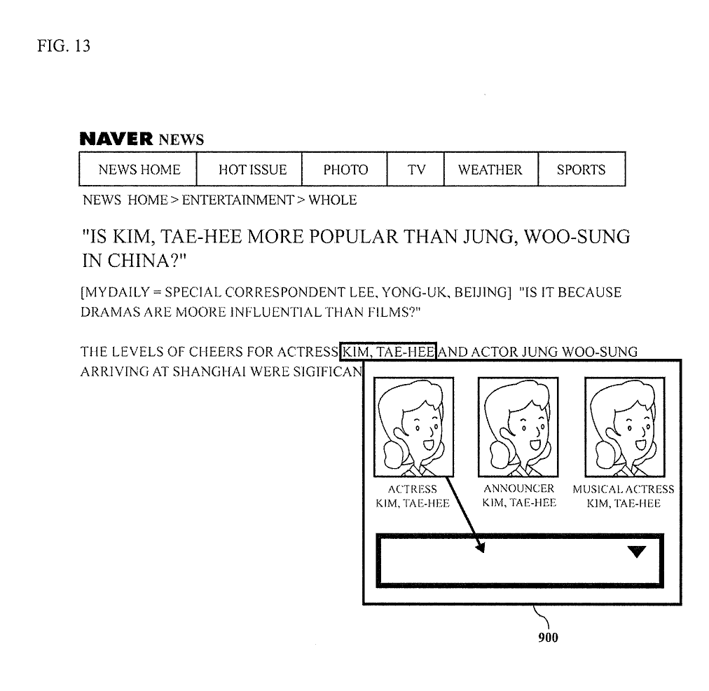

Further, FIGS. 11 to 14 are web pages for providing a search service about a person. FIG. 11 illustrates a detailed information page about movies including a person-GUI-search area, FIG. 12 illustrates a detailed information page about music including a person-GUI-search area, FIG. 13 a news article page including a person-GUI-search area, and FIG. 14 illustrates a search result page including a person-GUI-search area.

Specifically, while a user checks detailed information about a certain genre such as a movie or music or reads a news article or a search result, he or she can obtain a detailed search result for a person, whose appearance he or she only remembers, by moving the image of the person to the search box 900.

As such, the search server 102 according to an embodiment of the present invention can provide a desired search result to the user even in the case where the user does not input the information about the person using a text.

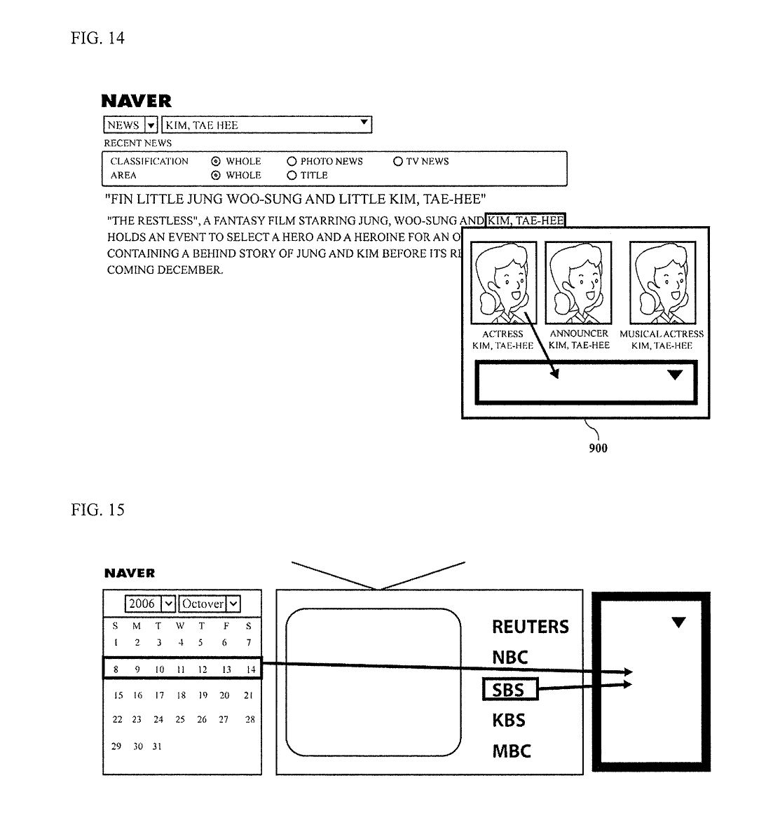

Further, the search service according to an embodiment of the present invention can also be applied to a broadcast search, as illustrated in FIG. 15. According to an embodiment of the present invention, a desired broadcast program can be searched by moving a broadcast date image and a broadcast company image to the search box 900 in the GUI-search area, as illustrated in FIG. 15.

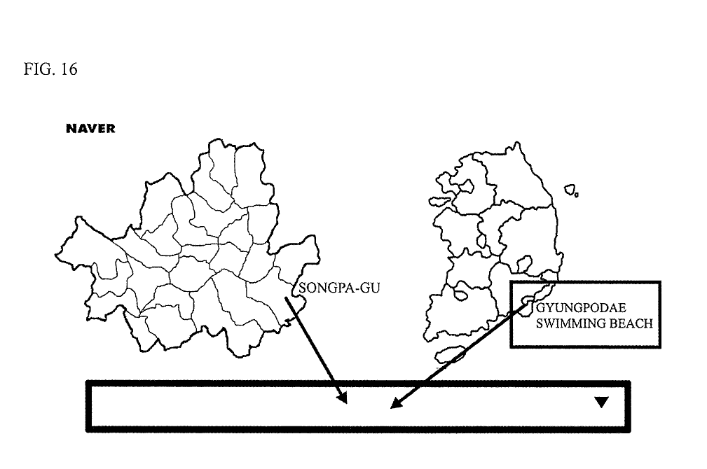

Further, in the case where a search service according to an embodiment of the present invention is applied to a route search, a web page including a GUI-search area as illustrated in FIG. 16 can be provided, a user can find a desired route by moving the image of the departure point and the image of the destination to the search box 900.

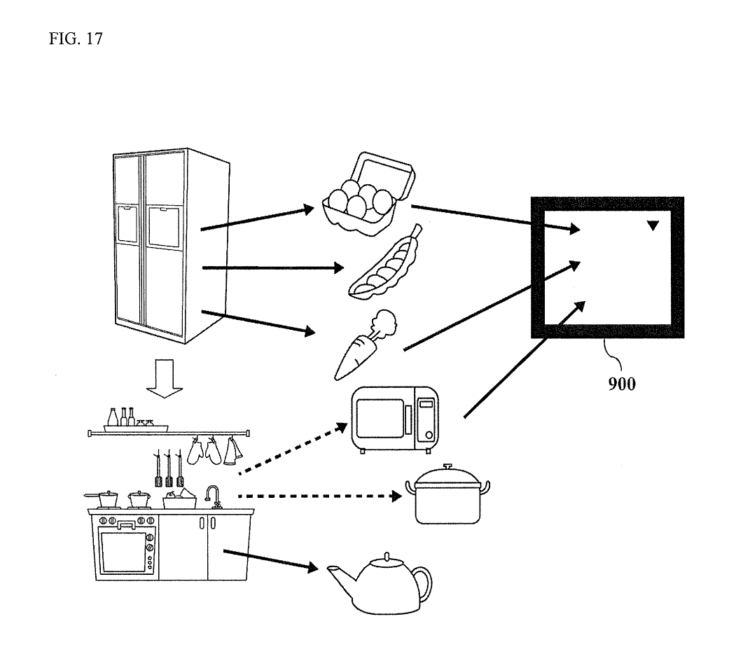

FIG. 17 illustrates an example where a search service of an embodiment of the present invention is applied to a cooking search, and a user can obtain a search result about recipes for dishes that can be made by the ingredients and tools the user currently has by moving one or more images of the ingredients and tools to the search box 900.

Moreover, the search service according to the an embodiment of present invention can be applied to various searches such as a region search using images about business categories, a music search using images of musical instruments, a wine search using wine images, a travel search using thumbnail images of travel areas or hotels, and a book search using book cover images.

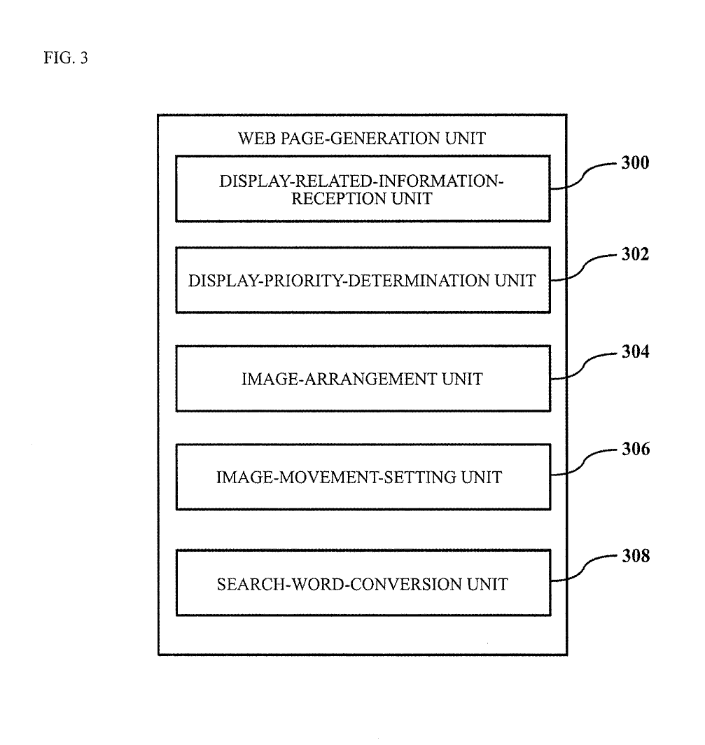

The detailed configuration of a search server according to an embodiment of the present invention will be described in the following with reference to FIG. 2.

FIG. 2 is a block diagram illustrating the detailed configuration of a search server according to an exemplary embodiment of the present invention. As illustrated, the search server 102 includes a data-collection unit 200, a client-communication unit 202, an image-extraction unit 204, a search-result-extraction unit 206, a web page-generation unit 208, a search-word-matching unit 210, a display-related-information-storage unit 212, and a control unit 214.

The data-collection unit 200 corresponds to a search robot, and collects website information at regular intervals or when requested by the user. The data-collection unit 200 mechanically moves around each website, reads web pages linked to the website, and collects the information of the web pages.

The data-collection unit 200 classifies collected website information, that is, “site identifier (ID)”, “site uniform resource locator (URL)”, “site title”, “site description”, “category identifier (ID)” to which the site belongs, “web page identifier (ID)” of one or more web pages included in the site, “web page URL”, and “HTML data” included in the web page”, by fields, and stores the classified information in the database 104.

Further, the data-collection unit 200 indexes the web site information collected through an indexing means (not shown). Here, the web site information can be indexed using the weight given to each set of web site information.

The client-communication unit 202 receives a transmission request to a web page or a search request using the selection of an image from the user client 108. Further, the client communication unit 202 transmits the web page according to the user's request to the user client 108. According to an exemplary embodiment, the user's request for transmission of a web page can include a request for transmission of a main page, a request for transmission of a search result page within a category by selection of a certain category, a request for a detailed information page about a movie or music, and a request for transmission of a search result page by the input of a text. The GUI-search area can be included in such a web page.

When receiving a transmission request to a web page, the image-extraction unit 204 extracts an image that can be included in the web page according to the request, and the extracted image is included in the GUI-search area included in the web page.

The search-result-extraction unit 206 extracts a search result corresponding to a text-type search word inputted from the user client 208, and if the user moves one or more images from images included in the web page to the search box 900, and sends a search request, the search-result-extraction unit 206 extracts a search result corresponding to the search word matched with the image.

The web page-generation unit 208 generates a main page corresponding to the user's request, a page corresponding to a certain category, and a search result page. Here, the GUI-search area included in each web page is also generated.

The web page-generation unit 208 according to an exemplary embodiment of the present invention generates a GUI-search area so that the image included in the GUI-search area can move to the search box 900 by the user's selection (e.g., a mouse click).

Further, because showing all images corresponding to a certain category can make selection of a desired image more difficult, according to an exemplary embodiment, the web page-generation unit 208 arranges images to be displayed according to predetermined priorities. Here, the web page-generation unit 208 can display a plurality of images in a rolling method by providing a rolling interface 902 in the GUI-search area, as illustrated in FIG. 10.

Further, the web page-generation unit 208 can allow a user to select images included in the web page and move the selected images to the search box 900 using various methods illustrated in FIGS. 11 to 14.

The search-word-matching unit 210 matches search words for a certain image. As stated above, the search words matched with a certain image can include a general-recognized word for the image and an alias group including one or more aliases for the word.

The display-related-information-storage unit 212 stores display-related information about a plurality of images included in the GUI-search area within the web page. As stated above, in the case where all images cannot be displayed in the GUI-search area, the display order needs to be determined according to determined priorities.

For this, the display-related-information-storage unit 212 stores the number of times searched, the number of times recommended, and information of whether a certain image was registered for advertisement. Here, because such information can be updated in real time, the display-related information according to an embodiment of the present invention also can be updated in real time.

The web page-generation unit 208 appropriately arranges images within the GUI-search area based on the display-related information.

The control unit 214, which controls the function of the search server 102, controls processes of website information collection, communication with the user client 108, extraction of search results, extraction of images, and web page generation.

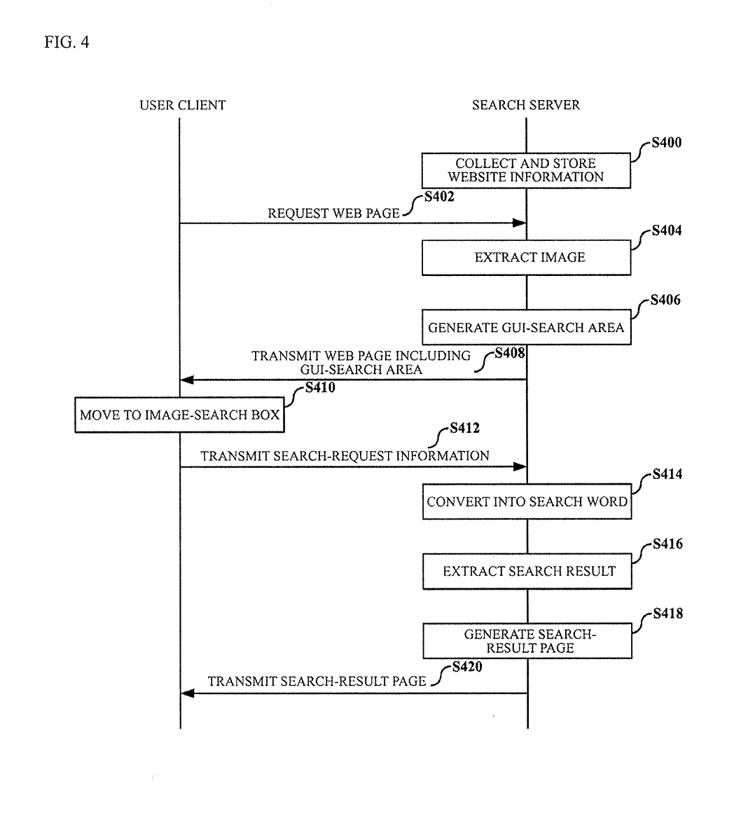

FIG. 3 illustrates the detailed configuration of a web page-generation unit according to an exemplary embodiment of the present invention, and illustrates a process of generating a GUI-search area included in a web page in detail.

As illustrated in FIG. 3, the web page-generation unit 208 includes a display-related-information-reception unit 300, a display-priority-determination unit 302, an image-arrangement unit 304, an image-movement-setting unit 306, and a search-word-conversion unit 308.

The display-related-information-reception unit 300 receives display-related information about images extracted for generating a GUI-search area from the display-related-information-storage unit 212. As stated above, the display-related information can include the number of times searched, the number of times recommended, advertisement information of images, and all other information for determining images in which many users might be interested.

The display-priority-determination unit 302 determines image-display priorities based on display-related information. As stated above, the display-related information about images can exist in various forms. As such, the display-priority-determination unit 302 can determine priorities for display by granting the weight to certain display-related information and adding up the points.

The image-arrangement unit 304 arranges a plurality of images according to the determined priority. As stated above, the images can be arranged in a rolling method.

The image-movement-setting unit 306 sets images included in the GUI-search area so that the images can be move to the search box when a user selects certain images. The setting can be implemented using the above-stated JAVA Script, Ajax or other web-image-editing program.

Further, when a user moves one or more images to the search box 900 to send a search request, the search-conversion unit 308 converts the images included in the search box 900 into the matched search words. Specifically, if a web browser installed in the user client 108 transmits identification information about one or more images selected by the user to the search server 102, the search-word-conversion unit 308 converts the selected images into the search words matched with the images, and provides the matched search words to the search-result-extraction unit 206.

As stated above, according to an embodiment of the present invention, a plurality of words can be matched with one image, and the search-word-conversion unit 308 converts each image to the search words matched with the image.

Further, in another exemplary embodiment of the present invention, one or more images selected by the user can be converted into search words matched with the images in the user client 108 by providing application program including the function of the search-word-conversion unit 308. Here, the web browser installed in the user client 108 transmits the search-request information including the converted search words to the search server 102, and the search result provided by the search server 102 is outputted.

The process of providing the search service according to an embodiment of the present invention will be described in detail in the following.

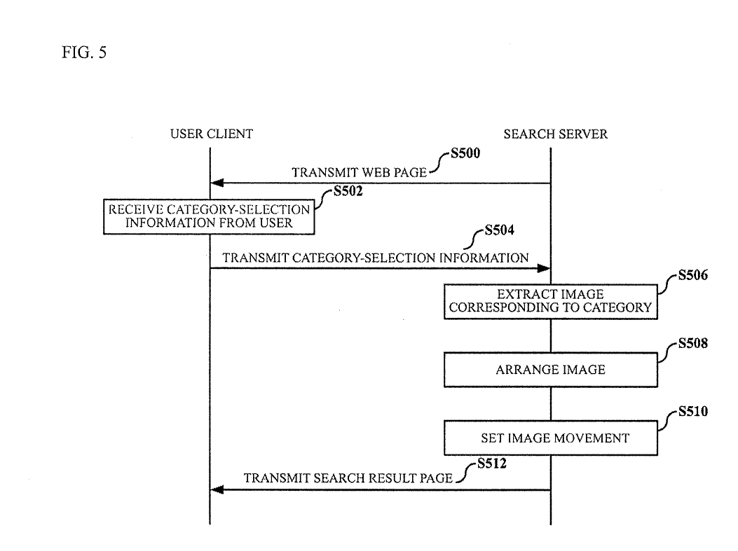

FIG. 4 is a flowchart illustrating the process of providing a GUI-search service according to an exemplary embodiment of the present invention.

Referring to FIG. 4, the search server 102 collects website information using a search robot, and stores the collected website information after indexing the information S400.

Then, when the user client 108 sends a transmission request to a predetermined web page to the search server 102 S402, the search server 102 extracts images that can be included in the web page requested by the user S404, and generates a GUI-search area using the extracted images S406.

The web page request transmitted from the user client can include requests for a main page of a search-service-providing site, a detailed information page about a certain category, and a search-result page.

The process of S406 can include the process of appropriately arranging extracted images according to predetermined standards, and setting the arranged images to be movable.

The search server 102 transmits the web page including the GUI-search area to the user client 108 through the above-stated process S408.

Further, the user client 108 outputs the web pages including the GUI-search area, and when the user send a search request by moving one or more images included in the GUI-search area to the search box 900 S410 to S412, the search server 102 converts the selected images into the search words matched with the images S414.

Then, the search server 102 extracts the search result corresponding to the above-stated search words S416, and generates a search-result page including the search result S418. Further, according to an embodiment of the present invention, in the case where images are included in the search result in step S418, a GUI-search area including such images can be generated.

Then, the search server 102 transmits the search result page to the user client 108 S420.

FIG. 5 is a flowchart illustrating the process of providing a GUI-search service according to another exemplary embodiment of the present invention. FIG. 5 illustrates the process where the search server 102 provides a GUI-search-dedicated page about a certain category in the case where a certain category is selected.

Referring to FIG. 5, the search server 102 transmits a web page to the user client 108 S500. Here, the transmitted web page can include information about a plurality of categories such as shopping, a person, broadcasting, a route search and cooking, and can include the subcategory information of each category, for example, information about a camera, a mobile phone and a notebook computer in the case of shopping.

If a user selects a certain category for a GUI search, the user client 108 receives the selection information of a category selected by the user S502, and transmits the category-selection information to the search server 102 S504.

Then, the search server 102 extracts a plurality of images corresponding to the category selected by the user S506, and arranges the extracted images according to predetermined standards S508. Then, the search server 102 sets the arranged images to be movable S510.

Through such processes, the search server 102 generates a GUI-search area, and the search server 102 transmits a web page including the GUI-search area to the user client 108 S512.

FIG. 6 is a flowchart illustrating the process of providing a search service according to another exemplary embodiment of the present invention. FIG. 6 illustrates the process where the search server 102 generates a GUI-search area, and transmits the search-result page in providing the search result requested by the user.

Referring to FIG. 6, the user client 108 transmits the search-request information to the search server 102 S600. Here, the search-request information can include the search request by the text input and the search request by the image selection.

The search server 102 extracts the search result corresponding to the search request S602. Here, the search server 102 also extracts the images included in the search result S604.

Then, the search server 102 arranges the extracted image according to predetermined standards S606, and sets the images to be movable S608.

Through the above-stated steps, the search server 102 generates a search result including a GUI-search area S610, and transmits the generated search-result page to the user client 108 S612.

The consecutive search service is available by allowing a GUI search in the search-result page.

FIG. 7 is a flowchart illustrating the process of providing a GUI-search service according to another exemplary embodiment of the present invention. As illustrated in FIGS. 18 and 19, FIG. 7 illustrates the process of updating images (or icons) about services where many users would be interested in predetermined areas 1800 of the web page requested by the user, and allowing a GUI search within the service range. Here, the service can refer to the search range such as real estate, news, blogs and specialized materials.

Referring to FIG. 7, the user client 108 sends a request for a main page to the search server 102 S700.

While processing statistics about a plurality of services S702, the search server 102 extracts images about a plurality of services S704, and arranges images extracted based on the statistic processing S706.

Here, the statistic processing can be the process of producing statistics about the number of times selected by the user about a certain service, and the service image is arranged using statistic information produced in advance S706.

In a modified embodiment, the service image can be arranged based on the service utilization information of the user, not the number of times selected by the user, in step S706.

Then, the search server 102 sets the service image to be movable according to the user's selection S708.

The search server 102 transmits the main page including the GUI search area including the search box 900 and the image-display area 1800 S710, as illustrated in FIGS. 18 and 19.

Here, the image-display area 1800 can be implemented using JAVA Script and Ajax, and updates the display order of the service images through the communication with the user client 108 and the search server 102 regardless of the user's request S712.

Further, the user client 108 monitors the movement of the service images to the search box 900 S714, and sets the service image included in the search box 900 as the search range about the search word inputted after the monitoring S716.

As illustrated in FIG. 19, the service image selected by the user can be indicated as a tab 1802 in a predetermined area adjacent to the search box 900, and when the user additionally selects service image, the corresponding tab may be additionally generated. The selected service images can be deleted by the user's selection, thereby the search range can be changed.

Then, when the user inputs predetermined search words in the search box 900 S718, the user client 108 transmits the search-request information to the search server 102 S720.

Here, the search-request information of S720 can include information about predetermined search ranges as well as information about the search words.

The search server 102 generates the search-result page corresponding to the received search words and search ranges S722, and transmits the page to the user client 108 S724.

Here, the search-result page provided to the user can be a new page that substitutes the original page, or a separate page while remaining the original page.

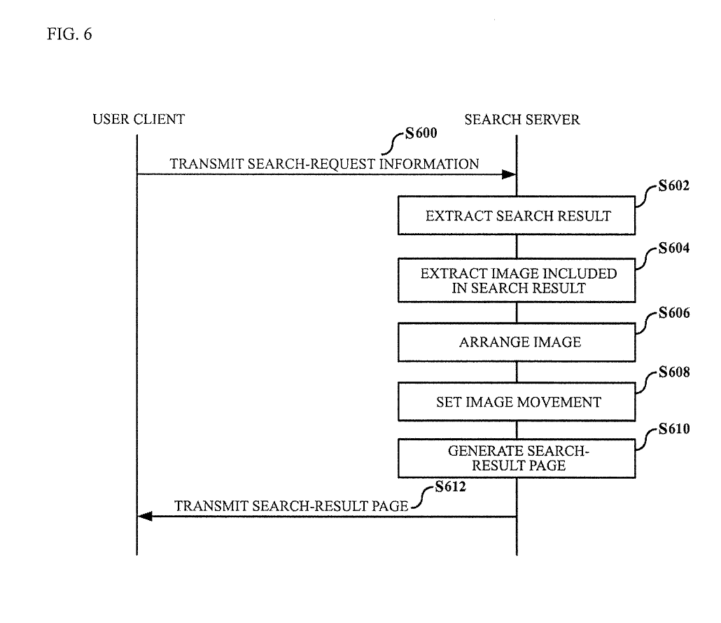

FIG. 8 is a flowchart illustrating the process of generating a GUI-search area according to an exemplary embodiment of the present invention.

Referring to FIG. 8, the search server 102 matches certain images with certain words S800. As stated above, the search words matched with the images include an alias group consisting of one or more aliases corresponding to the images.

Further, search server 102 conducts statistic processes about the search-requested images S802. Here, the statistic processes can include statistic processes about the number of times search-requested and the number of times recommended.

Then, the search server 102 extracts images which will be included in the web page S804. Here, the extracted images can include an image displayed in a predetermined area of a main page, an image included in the search result, and an image corresponding to a certain category.

The search server 102 determines display priorities for the extracted images using the processed statistic information and advertisement information of whether the advertisement for certain images was requested S806, and arranges images according to the priorities S808.

Then, the search server 102 sets each image to be movable according to the user's selection S810.

Through such steps, by providing a web page including a GUI-search area, an embodiment of the present invention easily sends a search request through the displayed images without the process of analogizing texts or inputting all aliases, thereby providing a search result for all aliases at one time.

It should be understood by those of ordinary skill in the art that various replacements, modifications and changes may be made in the form and details without departing from the spirit and scope of the present invention as defined by the following claims. Therefore, it is to be appreciated that the above described embodiments are for purposes of illustration only and are not to be construed as limitations of the invention.

The method and apparatus of embodiments of the present invention has the following advantages.

First, because a user can do a search using an image, the user does not need to analogize the text corresponding to the image to input the search word, which makes a search easy and convenient.

Second, because image is matched with all image-related words and provided, in the case where the user selects one or more images, and sends a search request, the user can receive the search results about all aliases related with the image.

Third, because the user can set the search range through the service image, the user can obtain the optimal search result within a desired search range.

Embodiments of the invention may be modified in many different forms, and the invention should not be construed as being limited to the exemplary embodiments set forth herein. Embodiments are provided so that this disclosure will be thorough and complete and will fully convey the concept of the invention to those skilled in the art, and the scope of the present invention will only be defined by the appended claims.

What is claimed is:

1. A method of operating an image-based searching engine, comprising:
sending, to a user's terminal, data for a plurality of images displayed on a web page;
receiving, from the user's terminal, a user's input comprising a selection of at least one of the plurality of images;
providing at least one search term associated with the selection;
conducting a search using the at least one search term; and
sending a result of the search to the user's terminal.

2. The method of claim 1, wherein the at least one search term is provided using a database, which comprises a plurality of entries, wherein each entry comprises an image and an term associated with the image.

3. The method of claim 1, wherein the user's input comprises two or more images of materials for use in cooking, wherein the search result comprises at least one of a name of food or a recipe that are prepared using the materials.

4. The method of claim 1, wherein the user's input comprises at least one image of cookware or a kitchen appliance, wherein the search result comprises a link for a web page including a recipe for food that uses the cookware or kitchen appliance.

5. The method of claim 1, wherein the plurality of images comprises a map of a region, which comprises a plurality of selectable sub-regions, wherein when the user's input comprises an image of the sub-regions.

6. The method of claim 1, wherein the user's input comprises an image representing a broadcast service provider and a date, wherein the search result comprises a broadcast schedule of the broadcast service provider on the date.

7. The method of claim 1, wherein the user's input comprises an image of a product available at an Internet store, wherein the search result comprises at least one of the name of Internet store and a link to open the Internet store's web page.

8. The method of claim 1, wherein the data is configured to arrange the plurality of images on the web page based on at least one selected from the group consisting of:
advertisement information of whether images were registered for advertisement; and
popularity of images during a prior operation of the image-based searching engine.

9. A method of using an image-based searching service, comprising:
selecting at least one image from a plurality of images displayed on a web page for image-based searching service;
subsequently sending a request for an Internet search, wherein the request identifies the at least one selected image; and
receiving a result of the Internet search comprising a plurality of links to open Internet web pages.

10. The method of claim 9, wherein selecting comprises dragging and dropping the at least one image into a designated area of the web page.

11. The method of claim 9, wherein the search is conducted using at least one term associated with the at least one selected image, wherein the at least one term is provided using a database, which comprises a plurality of entries, wherein each entry comprises an image and an term associated with the image.

12. A method of operating an image-based searching engine, comprising:
receiving a transmission request to a web page from a user client;
extracting at least one of image to be included in the web page from a database;
generating a first GUI-search area including the extracted image;
transmitting the web page that includes the first GUI-search area to the user client; and
when a search request to at least one of the image included in the first GUI-search area is received from the user client, transmitting a search result corresponding to the search-requested image to the user client.

13. The method of claim 12, further comprising:
matching the image with the search words corresponding to the image,
wherein the search words include one or more aliases related with the images.

14. The method of claim 13, wherein the transmitting the search result includes converting search words matched with the search-requested image, and wherein transmits the search result corresponding to the search words to the user client.

15. The method of claim 12, wherein the generating the first GUI-search areas includes setting the extracted image to be movable, and generating a search box that can contain the set image.

16. The method of claim 15, wherein the transmitting the search result transmits the search result corresponding to the image contained in the search box to the user client.

17. The method of claim 12, wherein the transmitting the search result comprises generating a second GUI-search area including the image included in the search result, and generating a search-result page including the second GUI-search area.

18. The method of claim 12, wherein the web page transmitted to the user client includes one or more sets of category information, and wherein further comprising generating a third GUI-search area including at least one of image corresponding to the selected category when the user's category-selection information is transmitted from the user client.

19. The method of claim 12, further comprising:
generating a fourth GUI-search area including at least one of service image where the service includes information about a search range;
transmitting the web page including the fourth GUI-search area to the user client; and
when the selection information about the service image and search-word information inputted by the user are received from the user client, transmitting the search result corresponding to the search-words within the search range corresponding to the selected service image.

20. The method of claim 19, wherein the generating the fourth GUI-search comprises updating the display order of the service image in real time using statistic process information.
